(19) United States
(12) Patent Application Publication
(10) Pub. No.: US 2011/0131812 A1
(43) Pub. Date: Jun. 9, 2011

(54) Electrically Operated Hair Cutting Device

(76) Inventors: Andreas Erndt, Kelkheim (DE); Daniel Dietzel, Kelkheim (DE); Thorsten Piesker, Friedrichsdorf (DE); Johannes Stimpel, Bad Homburg (DE); Nicolas Salomez, Eschborn (DE); Uwe Ludaescher, Frankfurt (DE); Matthias Matern, Steinbach (DE)

(21) Appl. No.: 12/959,721

(22) Filed: Dec. 3, 2010

(30) Foreign Application Priority Data
Dec. 4, 2009 (EP) 09015037.6

(51) Int. Cl. B26B 19/04

(52) U.S. Cl. 30/34.1

(57) ABSTRACT

The present invention relates to an electrically operated hair cutting device having a short hair cutting system fashioned on a front end of a housing and having a bearer part, attached to the front or rear side of the housing, that accepts at least one additional cutting device. The cutting device is made up of at least two cutting elements that slide relative to one another via a drive motor, the cutting elements of the additional cutting device being fashioned in a shaving head frame. The shaving head frame, with the cutting elements, is mounted in the bearer part against the force of a spring system. In addition, the shaving head frame is guided upward and downward in the bearer part via guide elements. According to the present invention, the shaving head frame is pivotably mounted on the bearer part via a central bearing. In this way, a shave is ensured that is particularly gentle to the skin.

### FIELD OF THE INVENTION

The present invention relates to an electrical hair cutting device.

### BACKGROUND OF THE INVENTION

EP 1 641 601 B1 discloses a hair cutting device in which a bearer element is attached to the front side of the razor housing, on which element there is situated, diametrally opposite, a respective cutting device formed as a long hair trimmer that is driven in simultaneously oscillating fashion after switching on and displacement of the sliding switch. Together with the cutting device, the bearer element can be pivoted about an axis of rotation, so that in the one position the cutting device can be used with the long cutting combs and in the other position the cutting device can be used with the shorter cutting combs. If the sliding switch is brought for example into position 1, shaving can take place with the short hair cutting system.

If the sliding switch is brought into position 2, one of the two upward-directed cutting devices moves far enough out of the razor housing that the cutting combs protrude past the short hair cutting system. Thus, when the cutting device is brought into contact with the surface of the skin, only the front cutting device, provided with the comb arrangement, is used. In this position, longer hairs can be supported. If for example the bearer element is rotated about its axis, the shorter cutting device comes into use, and for example side burns can be trimmed. The combs of the two front cutting devices can be moved only laterally back and forth relative to each other in the bearer part, so that it is not the case that the entire comb front can follow an uneven skin surface, which limits the comfort of the hair cutting device.

In addition, DE-4117990 A1 discloses a hair cutting device of the type described above in which the cutting device flange-mounted on the front side of the hair cutting device is made up of a comb-type trimmer that can be raised and lowered via a spring system on the bearer part. This has the advantage that the pressure forces applied from above by the skin surface of a user are held within limits, because when the pressure is too high the cutting device can escape downward against the force of the springs. Through this arrangement, pressure forces on the surface of the skin are kept within limits, promoting shaving comfort.

The object of the present invention is to create a hair cutting device in which the cutting device mounted in front of the short hair cutter enables better adaptation to the skin, thus improving the shaving result. At the same time, greater protection of the skin surface during shaving is intended to be enabled.

### SUMMARY OF THE INVENTION

This object is achieved by the present invention. Due to the fact that according to the present invention the shaving head frame is now mounted pivotably on the bearer element via a central bearing, and the bearing has play running in the upward and downward movement range of the shaving head frame, in addition to the uniform lowering of the cutting unit and thus also of the shaving head frame the frame can additionally be pivoted about the central bearing in the clockwise or counterclockwise direction, which makes possible an oblique positioning of the additional cutting device, and also makes it possible for this device to better follow the surface of the skin. This results in a more gentle shaving process, because the cutting device can lie uniformly against the skin without requiring great exertion in the users shaving movements. A slight rotation, in the clockwise or counterclockwise direction, of the cutting device is superposed on the uniform lowering of the cutting device, improving the degree of freedom of the movement of the contact surface of the cutting device. In this way, an even more gentle and more thorough shave is enabled according to the present invention.

In order to enable a pivoting movement that is rotatable about the central bearing within small limits, in addition to the upward and downward movement of the cutting device, according to one embodiment of the present invention, this bearing consists of a pin formed on the shaving head frame that engages in a groove formed on the bearer element. This groove is dimensioned long enough in the direction of the upward and downward movement of the shaving head frame that it permits the movement of the pin. Thus, the cutting device is laterally guided by the pin via the groove, and can nonetheless slide upward or downward along this groove. This makes possible a rotation of the cutting device about the pin, which in addition to the uniform lowering enables a further lowering of the left or right side of the cutting device in the clockwise or counterclockwise direction. Due to the groove-pin construction, the cutting device can be mounted on the bearer element particularly easily.

Another embodiment of the present invention provides that the oscillating movement can be transmitted to the cutting device in nearly frictionless fashion. Here, the pivoted lever, which is drivable by the drive motor, engages, via a coupling arrangement, in an access of the one cutting element, which moves back-and-forth, the coupling arrangement having means that permit both rotation and an upward and downward movement of the corresponding cutting element. In this way, the oscillating movement can also easily and economically be transmitted to the cutting element that moves back-and-forth, even during lowering or rotation. For this purpose, an embodiment of the present invention describes that the means are made up on the one hand of a fork-shaped claw, formed on the free end of the pivot lever, that engages in a shaft formed on the cutting element, such that in the initial position of the one cutting element there is a space between the free end of the claw and the end of the shaft. At the same time, the end surfaces of the claw, which are in sliding contact with the walls of the shaft, are curved outward. Through this measure, the rotation of the one cutting element on the pivot lever is compensated. At the same time, the oscillating movement can be transferred to the one cutting element almost without play and with low friction.

According to another embodiment of the present invention, the shaving head frame is supported via two springs that engage on the outer ends, said springs being fixedly clamped to the bearer element. In this way, the springs absorb not only pressure forces that occur during the upward and downward movement, but when a pivot movement is introduced they can also absorb transverse forces through which, when the cutting unit is not loaded, this unit always moves back continuously into its horizontal initial position.

According to another embodiment of the present invention, between the shaving head frame and the bearer element stop means are provided that present the cutting device or the shaving head frame from sliding out of the bearer part, and simultaneously pre-tension the cutting unit in the upward movement direction in such a way that given even the slightest lowering of the cutting unit, a certain force is necessarily applied to this unit. At the same time, due to their pre-tension on the one hand and the stop means on the other hand, the springs ensure that the cutting unit always returns to the prespecified initial position after a shaving process.

According to another embodiment of the present invention, the bearer element is mounted on a sliding switch that can be displaced on the housing of the shaving apparatus, the bearer element and the sliding switch being capable of being moved into various positions together. Due to the fact that the bearer element is borne by the sliding switch on the housing of the hair cutting device, when the sliding switch is displaced it is carried upward along with it, and can thus assume a position that extends past the position of the short hair trimming system. In this position 3, shaving is then possible only with the trimmer, or long hair cutter, that is positioned before the short hair cutting system. In position 1 of the sliding switch, the pre-positioned cutting device is also extended slightly, but here only to such an extent that only the short hair cutting device is fully accessible for shaving the skin surface. However, there can also be a middle position, in which position 2 is assumed, in which the pre-positioned cutting device is situated at approximately the same level as the short hair cutting system. This then enables combined shaving using both cutting systems. In this case, there are then four positions of the sliding switch, namely: the null position; position 1, in which the drive motor is switched on and the short hair cutting system is activated; position 2, in which the cutting system situated before the short hair cutting system is activated and is simultaneously brought to the height of the short hair cutting system in order to enable combined shaving; and, finally, position 3, in which the pre-positioned cutting system is brought past the short hair cutting system, so that only long hair trimming is possible.

According to another embodiment of the present invention, the two cutting systems are advantageously actuated by common drive means, which keeps down construction and assembly outlay, as well as manufacturing costs.

It is advantageous if, according to another embodiment of the present invention, the bearer element and the sliding switch are mounted in linearly displaceable fashion on the housing of the shaving apparatus. This enables simple manual operation.

According to another embodiment of the present invention, a preferred development of the present invention provides that two cutting systems, situated diametrally opposite one another, are mounted in the bearer element, the axis of rotation advantageously running eccentrically relative to these two cutting systems. Thus, when the bearer element is pivoted relative to the housing of the hair cutting device, both the cutting system to be used can be changed and the relative position of the cutting system to the housing can be modified. In this way, various types of shaving, such as trimming, long hair cutting, or fine cutting, can be enabled in a single shaving apparatus.

According to another embodiment of the present invention, on the bearer element there are fashioned two cutting devices, of which one performs a trim function and the other performs a long hair cutting function, the latter also enabling combined shaving, so that in a first working step the longer hairs are cut using the long hair cutter, and in the second working step the remaining hairs are cut using the short hair cutter.

Further goals, features, advantages, and possible uses of the present invention result from the following description of the exemplary embodiments. Here, all described or graphically represented features, alone or in any combination, form the subject matter of the present invention, independent of their summarization in the claims or the dependencies thereof.

### BRIEF DESCRIPTION OF THE DRAWINGS

An exemplary embodiment of the present invention is shown in the drawing and is explained in more detail below.

FIG. 1 shows a perspective view of a first exemplary embodiment of a hair cutting device according to the present invention from the right front, but in an enlarged view, the sliding switch and thus the long hair cutting system situated before the short hair cutting system having reached the extended shaving position, but the long hair trimmer assuming its initial position,

FIG. 2 shows a representation as shown in FIG. 1, but here through uniform application of force on the long hair cutter from above, this cutter has assumed its lowest position, running perpendicular to the longitudinal axis of the hair cutting device,

FIG. 3 shows a representation as shown in FIG. 1, but here the long hair cutter has assumed a position that is slightly pivoted in the clockwise direction, due to the application of force from the upper right,

FIGS. 4 through 7 show four perspective front views of a bearer element of a second exemplary embodiment having cutting devices that are situated diametrally opposite one another, the upper cutting device, fashioned as a long hair cutter, being shown in four possible different extreme positions,

FIG. 8 shows a perspective partial view according to FIG. 1 from the rear left of the interior of the bearer element with the rear housing cover removed, a partial section in the longitudinal direction having been made through the hair cutting device in the upper left region,

FIG. 9 shows a perspective exploded view according to FIG. 1 from the front, of the bearer element with front cover removed,

FIG. 10 shows a perspective partial view from the rear right, in a somewhat reduced scale, corresponding to FIG. 8, of the interior of the bearer part with the rear housing cover removed; here, however, in the left half of the view the supporting foot has been removed in order to show the arrangement of the locking lever situated behind it,

FIG. 11 shows a center section according to section line XI-XI according to FIG. 1; here, however, a small part of the lower housing part of the shaving apparatus has been broken away,

FIG. 12 shows a center section according to sectional line XI-XI, but viewed here from the left, through the bearer element, mounted on a sliding switch and having the integrated cutting devices, but in a greatly enlarged scale relative to FIG. 11, and

FIG. 13 shows a partial section V in the area of the central bearing of the shaving head frame on the bearer part.

### DETAILED DESCRIPTION OF THE INVENTION

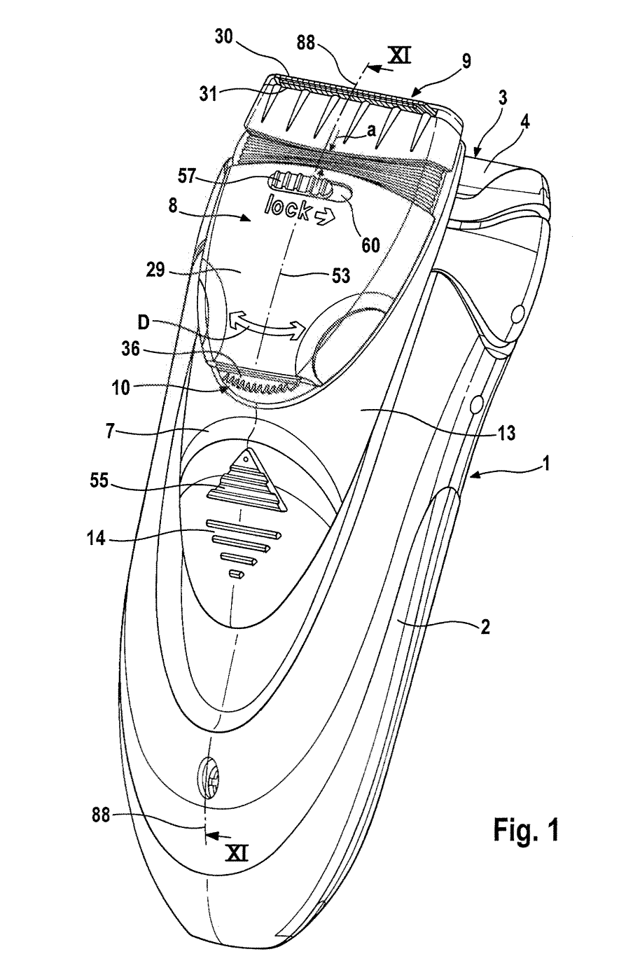

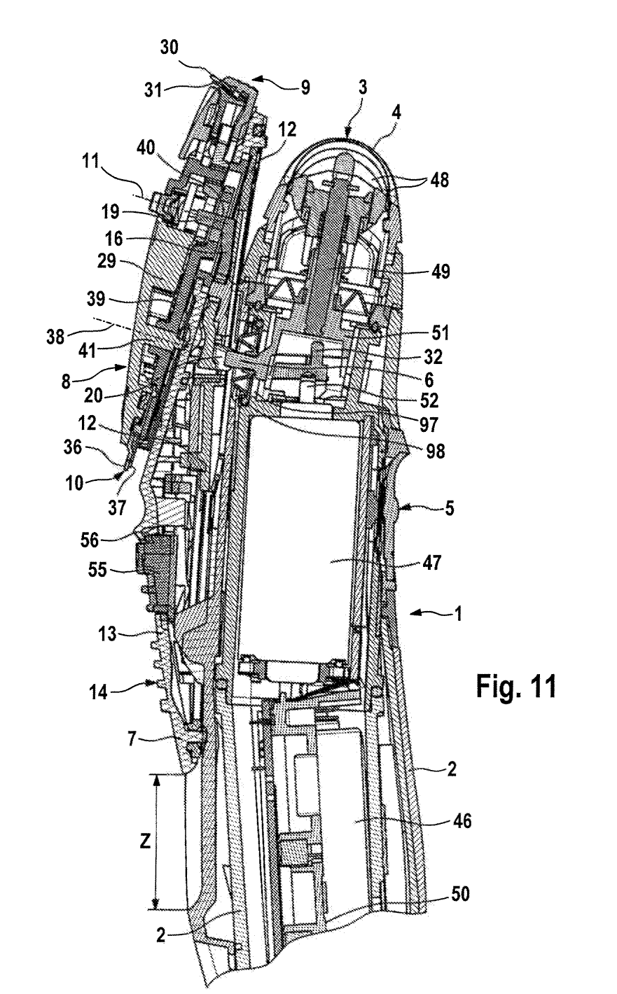

The perspective view according to FIGS. 1 through 3 shows a known hair cu device 1, fashioned as an electric shaver, having a housing 2 and a short hair cutting system 3. Short hair cutting system 3 is made up of an upper blade 4, fashioned as a shaving foil, under which, according to FIG. 11, a lower blade 48 is moved back and forth in oscillating fashion via a drive pin 49. Via an eccentric coupling 51, drive pin 49 is mechanically engaged with an eccentric pin 32. Eccentric pin 32 is mounted in rotationally fixed fashion on a drive shaft 52 of a drive motor 47. Housing 2 accommodates drive motor 47 required for this, as well as, if warranted, electrical storage cells 46, and/or a power and charging part 50 for supplying energy to drive motor 47.

According to FIG. 11, an on/off switch 5 is situated on the rear side of housing 2. This switch switches the supply of energy to drive motor 47, which in the switched-on state according to FIG. 11 drives lower blade 48 of short hair cutting system 3 in oscillating fashion while also acting as the permanent drive of a drive element 6 that protrudes from razor housing 2 via an opening 97. Opening 97 is sealed against a drive element 6 by a bellows seal 98 in order to prevent dirt from penetrating into the interior of razor housing 2. Drive element 6 is a part of eccentric coupling 51, and is driven in oscillating fashion as is lower blade 48, but perpendicular thereto.

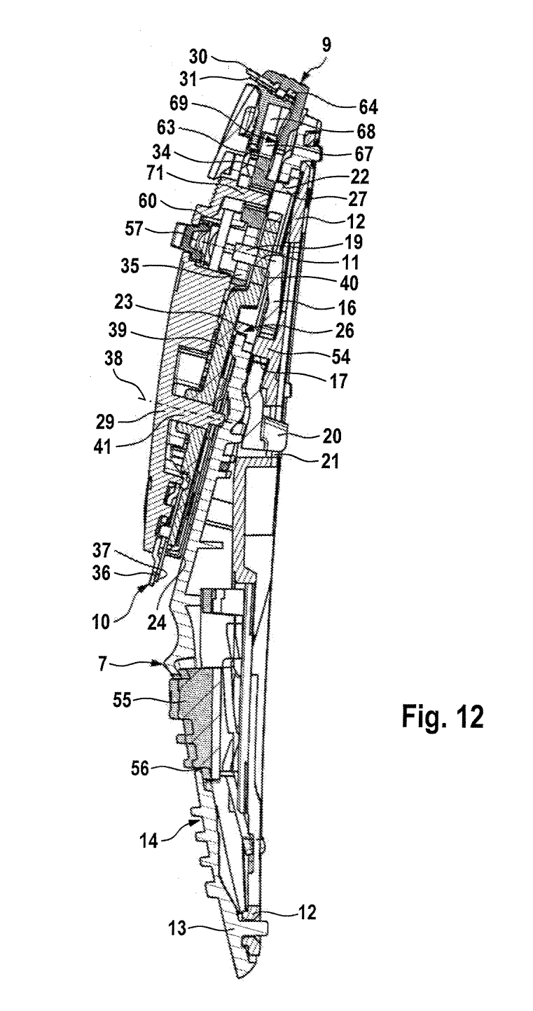

According to FIGS. 1 through 3, 11, 12, a sliding switch 7 is situated on the front side of housing 2, on which switch a bearer element 8 is mounted in which a first and second long hair cutting system 9 and 10 are situated diametrally opposite one another. Sliding switch 7 is mounted so as to be displaceable in locking fashion along a longitudinal axis 53 (FIG. 1) of housing 2 from top to bottom and vice versa. According to FIG. 12, bearer element 8 is mounted on sliding switch 7 so as to be pivotable about an axis of rotation of 11. Axis of rotation of 11 stands essentially perpendicular to the front side of housing 2. The linear displaceability of sliding switch 7 on housing 2 is realized using known measures such as slot-shaped longitudinal guides. These are not shown in more detail in the drawing.

The design of the pre-mountable assembly made up of sliding switch 7 and a bearer element 8 can be seen clearly in FIGS. 11 and 12. Sliding switch 7 is made up essentially of base plate 12 and covering shell 13, which is provided with recessed grips 14. Above recessed grips 14, in a recess 15 there is placed an arrest switch 55 (strongly hatched) that after its actuation releases sliding switch 7 so that it can move out of its initial position (not shown). Base plate 12 is used to mount sliding switch 7 on housing 2 so as to be capable of longitudinal displacement.

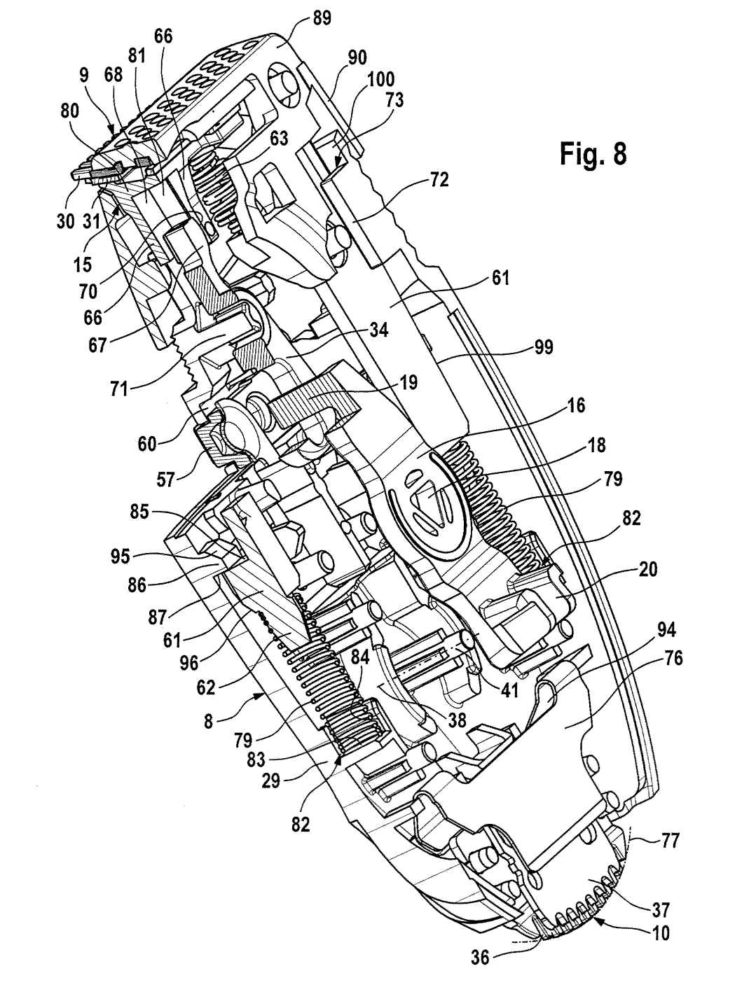

According to FIGS. 8, 10, 11, and 12, a double lever 16 is mounted, via its bore or recess 18, on base plate 12 on a pin 54 (FIG. 12), said pin forming at its outer circumference 17a bearing point that effects the rotatable bearing of double lever 16 on base plate 12. On the upper end of double lever 16, there is situated a drive pin 19 that extends transversely in the direction towards and through cover shell 13, while at the lower end there are fashioned coupling flanges 20 that also extend transversely but that run in the opposite direction, i.e. toward the interior of housing 2. Coupling flanges 20 extend through an opening 21 provided in base plate 12.

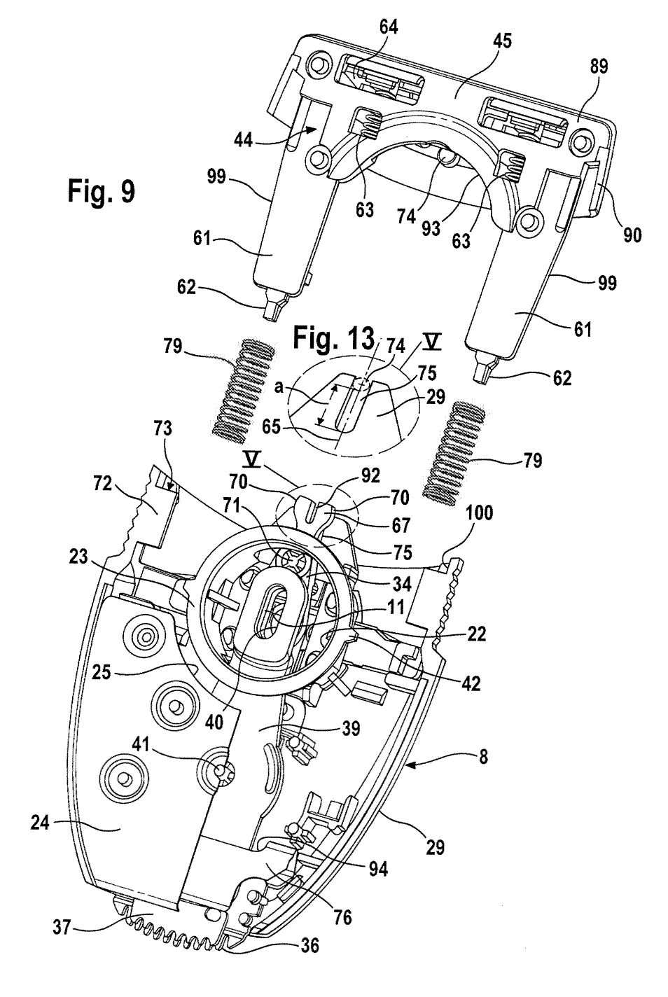

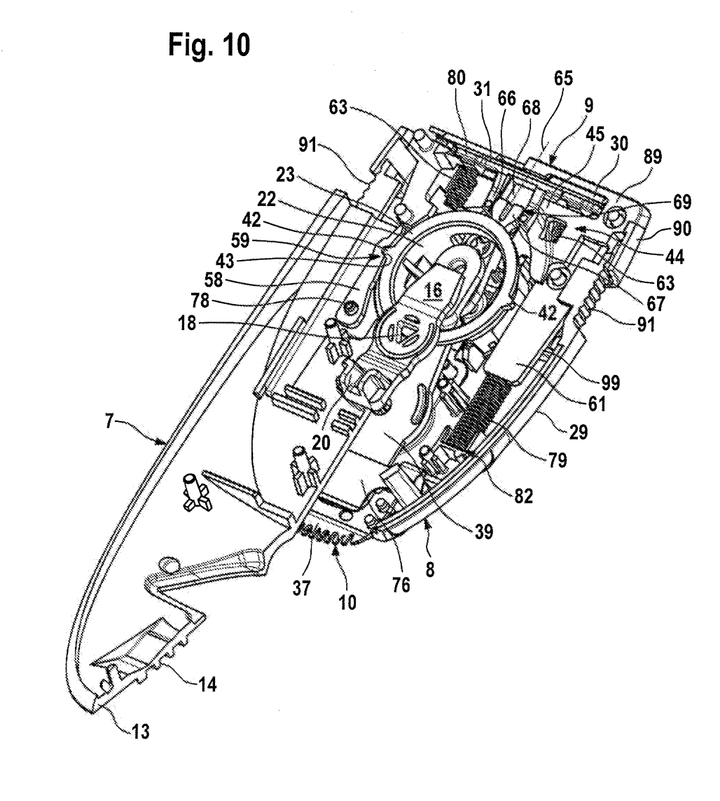

In the upper third of cover shell 13, a circular segment 22 is provided that in the assembled state partly surrounds drive pin 19. Segment 22 runs concentrically around drive pin 19 when double lever 16 is in the center position shown in FIGS. 10 through 12. Segment 22 is bounded by a circulating collar 23 that acts as the bearing of an assembly plate 24 (FIG. 9). According to FIG. 12, assembly plate 24 has a circular segment 25 whose diameter is somewhat greater than that of segment 22. Assembly plate 24 and cover shell 13 are pivotably connected to each other by a rotary joint 26. Rotary joint 26 is made up of a bearing ring 27 on which two assembly guide pins (not shown) are formed that extend axially and are situated diametrally opposite one another. While assembly plate 24 on the front side of cover shell 13 lies against collar 23, bearing ring 27 contacts collar 23 on the rear or inner side of cover shell 13. The assembly guide pins pass through both segment 22 and circular segment 25, and, together with a circulating shoulder (not shown), act to center cover shell 13 and assembly plate 24.

The assembly guide pins each have two bores (not shown) that run axially and that accept corresponding fastening pins (not shown) that are provided on the inside of cover 29 of bearer element 8. The shell of bearer element 8 is thus composed of cover 29 and assembly plate 24, between which the two long hair cutter systems 9, 10 are integrated. The two long hair cutting devices 9 and 10 can be driven by drive pin 19, which engages through rotary joint 26. According to FIGS. 1 through 3 and 8 through 12, first long hair cutting device 9 is made up of a stationary cutting comb 30 and a linearly oscillating cutting blade 31, both cutting comb 30 and cutting blade 31 having a row of teeth that runs in a straight line. The edges of the cutting teeth thus form cutting edges that cut hairs that come between them.

According to FIG. 8, cutting blade 31 is guided in its back-and-forth movement by a linear bearing 15. According to FIG. 8, stationary cutting comb 30 is extrusion-coated at the top and at the sides with a housing part 89 made of plastic that is part of a shaving head frame. At the bottom of housing part 89, a circumferential collar 90 is connected to housing part 89, for example by gluing, welding, or a snap-on connection. Collar 90 extends downward far enough that it externally surrounds, with play, a fluted wall 91 of bearer part 8 or of cover 29. This ensures that a pivot S (FIG. 6 or 7) of shaving head frame 44 is possible. However, the play is kept small enough that coarse dirt cannot penetrate.

According to FIG. 12, cutting blade 31 stands in a drive connection, via a coupling arrangement 69, with a pivot lever 34 that has a receptacle 35 for drive pin 19. Receptacle 35 is fashioned as an oblong hole that extends vertically, whose width corresponds with a precise fit to the diameter of drive pin 19 in order to ensure a nearly play-free entrainment of a drive lever 39. Base plate 12 encloses an angle of approximately 15° with assembly plate 24; i.e., bearer element 8, with its two long hair cutting systems 9, 10, stands at this angle to base plate 12, and thus has the same angle to hair cutting device 1. Cutting comb 30 and cutting blade 31 enclose an angle with assembly plate 24 that is equal than or greater to 90°. This achieves a softer gliding of cutting comb 30 along the skin surface of a user.

Second long hair cutting device 10, which is fashioned with less than half the width of first long hair cutting device 9, but differs in that it runs approximately parallel to base plate 12 and approximately concentrically to axis of rotation 11, is made up, according to FIG. 8, of a stationary cutting comb 36 and a cutting blade 37 that is driven in pivotably oscillating fashion, these two elements being pressed against one another with a pre-tension by a U-shaped spring bracket 76. In its U-shaped area, spring bracket 76 has an opening 94 that runs transverse to longitudinal axis 88, through which drive lever 39 reaches oscillating cutting blade 37.

According to FIG. 8, the free ends of the rows of teeth of the two cutting elements 36, 37 lie on a circular segment 77 (FIG. 8) whose midpoint lies approximately on a pivot axis 38. Pivot axis 38 is formed by a pin 41 that extends inward on cover 29, on which drive lever 39, connected to cutting blade 37, is rotatably connected. A receptacle 40 for drive pin 19, also fashioned as an oblong hole, is provided on the end of drive lever 39 situated opposite cutting blade 37; said pin engages in said receptacle for the purpose of entrainment. Receptacles 35, 40 nm parallel to one another. Pivot point 38 is formed by pin 41, which is integrally formed on the inside of cover 29. The two cutting combs 30 and 36 are also fastened to the inside of cover 29.

Cutting blades 31 and 37 are situated between respectively allocated cutting combs 30 and 36 and assembly plate 24. The rows of teeth of the allocated cutting combs 30, 36 extends slightly past those of the cutting blades, so that there is no risk of injury to the user caused by driven cutting blades 31, 37.

As soon as double lever 16 is driven in oscillating fashion by drive element 6 (as described below), the two cutting blades 31 and 37 are set into oscillating movement, because both of these are engaged with drive pin 19. Through corresponding pivoting of bearer element 8, the two long hair cutting devices 9 and 10 are brought into the desired operating position. For this purpose, drive motor 47 does not have to be switched off or decoupled; rather, drive pin 19, oscillating about pivot bearing 18, can easily continue to drive the two cutting blades 31 or 37, due to its centering relative to rotary joint 26, or can move in receptacles 35 and 40, because these two run concentrically to one another.

If bearer element 8 is pivoted by 90° out of the initial position shown in FIGS. 1 through 7, as well as 11 and 12 (first long hair cutting device 9 is shown at the top and second long hair cutting device 10 at the bottom), the amplitude of the movements of cutting blades 31 or 37 decreases permanently to the value 0, because when there is a 90° pivot relative to the initial position the extensions of receptacles 35 and 40 agree with the oscillatory movement of drive pin 19, and this pin merely moves freely back and forth in the oval receptacles. If the pivot movement of bearer element 8 is extended further, i.e. from 90° to 180°, the amplitude of the oscillation of cutting blades 31 and 37 increases until, at a pivot of 180°, it has again reached its maximum value.

However, in order to enable a pivoting of bearer part 8, according to FIG. 8 an arrest slider 57 that is displaceable on cover 29 in a recess 60 must be unlocked; i.e., must be displaced horizontally from the right to the left according to FIGS. 1 to 3 until it has assumed the position shown in these Figures. According to FIG. 10, in the blocking position arrest slider 57 engages in a locking lever 58 that in turn prevents rotation of bearer part 8 via a ratchet [or: catch] arrangement 59. Ratchet arrangement 59 is made up of two protruding cams 42, situated diametrally opposite one another, that extend outward from collar 23 on bearing ring 27 of rotary joint 26. In the depicted operating position left cam 42 engages in spring-loaded locking fashion in a corresponding indentation 43 on locking lever 58. One-armed locking lever 58 is rotatably mounted on a bearing bolt 78 and is held in seated fashion on cam 42 by a spring (not shown).

According to FIG. 9, upper long hair cutting system 9 is made up of shaving head frame 44, which is essentially made up of a center part 45 and two support feet 61 that extend downward from the ends and on whose free ends centering pins 62 are fashioned. Shaving head frame 44 is formed by plastic injection-molded part in which cutting comb 30 and cutting blade 31 are situated, in a receptacle 64 in center part 45, cutting blade 31 being pressed uniformly against the underside of cutting comb 30 by springs 63. According to FIG. 8, springs 63 are supported in centering fashion on a rail 80 on the one side and on shaving head frame 44 on the other side, and are thus subject to a pre-tension. A lower wall 93 on center part 45 is fashioned as a circular are, and is situated at a slight distance from circumferential collar 23. Both have axis of rotation 11 as their midpoint.

According to FIG. 10, from rail 80, which is made of plastic and is sprayed, glued, or riveted onto metallic cutting blade 31, there extend two walls 66 that form a space or shaft 68 that accommodates a fork-shaped claw 67 which is formed on the upper end of pivot lever 34, said walls running downward parallel to one another and extending on both sides of center line 65 of bearer part 8, i.e. ultimately of shaving apparatus 1. Outer walls 70 of claw 67, which enter into contact with contact surfaces 81 (FIG. 8) of walls 66 of shaft 68, are curved outward in order to enable pivoting, but not tilting, of pivot lever 34 in shaft 68, with a small air gap. The spacing between contact surfaces 81 is dimensioned in such a way that claw 67 is seated in shaft 68 without play. Fork-shaped claw 67 has a central opening 92 (FIG. 9) that is upwardly open and that provides more elasticity in this area during operation of shaving apparatus 1, thus achieving greater shaving smoothness. Pivot lever 34 is rotatably mounted on pin 71 (FIG. 8), which extends inward on cover 29.

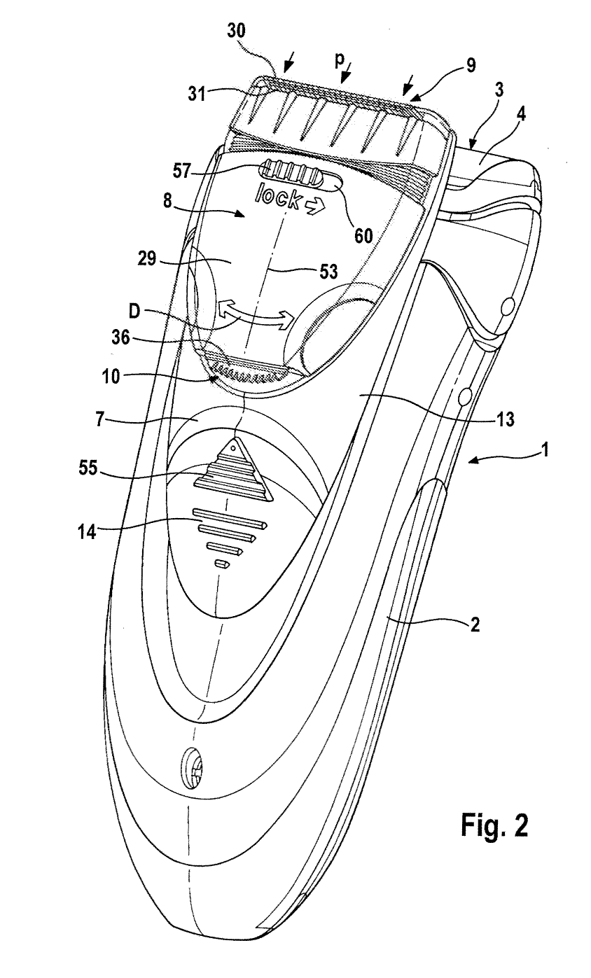

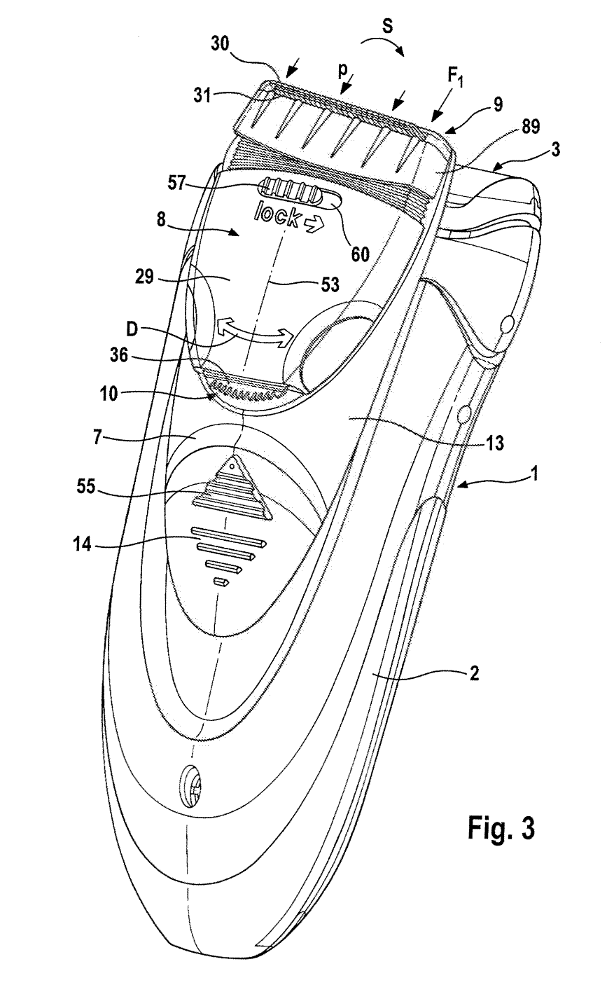

According to FIG. 8, supports 61 are formed by narrow strip-shaped rods that are partly enclosed from the outside by guide elements 72, which have U-shaped cross-sections, in the form of flanges. Flanges 72 nm vertically, and thus form a nearly play-free sliding guide 73 for shaving head frame 44, which as a result can move only vertically from top to bottom (FIGS. 2 and 5) and vice versa in bearer part 8. As FIG. 9 clearly shows, the width of support feet 61 tapers slightly downward in order to ensure that jamming or tilting does not occur in sliding, guide 73 when shaving head frame 44 pivots in the clockwise (FIGS. 3 and 7) or counterclockwise (FIG. 6) direction. Shaving head frame 44 pivots in pivot direction S (FIGS. 7 and 8) about a central bearing that, according to FIGS. 9 and 13 consists of a bearing pin 74 that is integrally formed on the shaving head frame and that engages in, and with an almost perfect fit to the sides of, a groove 75 that opens from the top on bearer element 8. Groove 75, which runs vertically, has a length such that when shaving head frame 44 moves up or down bearing pin 74 can move in unhindered fashion in this groove, but lies against the walls of the groove nearly without play so that it will not impair or reduce the oscillatory movement at the cutting blade.

According to FIG. 8, spiral springs under pressure 79 (here also simply referred to as the spring arrangement) are centered on centering pins 62 and are seated there. The other sides of spiral springs 79 are seated in pocket-shaped receptacles 82, supported on the floor 83 thereof. Laterally, they are centered by a tubular side wall 84. When shaving head frame 42 is assembled to bearing part 8, the two support feet 61 are introduced into sliding guides 73 and, according to FIG. 8, are pushed downward until support surfaces 85, fashioned on support feet 61, grasp snap hooks 86 that project inward on cover 29.

When support feet 61 are introduced into sliding guides 73, support feet 61 are first elastically pressed inward by snap hooks 86 until they snap into place. In order to facilitate this, nm-up ramps 95, 96 are fashioned on snap hooks 86 and on support feet 61. Here, spiral springs 79 are pre-tensioned in such a way that they support stop surfaces 85 at limit surfaces 87 of snap hooks 86 with pressure. While stop surfaces 85 nm perpendicular to longitudinal axis 88 of shaving apparatus 1, sliding guide 73 runs parallel to longitudinal axis 88. Longitudinal axis 88 forms the axis of symmetry of shaving apparatus 1; i.e., in their initial position cutting comb 30 and cutting blade 31 nm perpendicular to longitudinal axis 88.

The center area of spiral springs 79 is exposed, i.e. is not centered, so that in this area the slight lateral offset of centering pin 62 relative to receptacle 82 that occurs when shaving head frame 44 pivots about bearing pin 74 is resiliently absorbed. As soon as an eccentric force no longer acts on shaving head frame 44 from the outside, as a result of the torque formed in spiral springs 79, or the bending tension present here, said frame automatically returns to the initial position (FIG. 8); i.e., centering pins 62 return to alignment with the associated receptacles, and long hair cutting device 9 again runs parallel, or centrically, relative to longitudinal axis 88 of shaving apparatus 1.

The manner of operation of the hair cutting device according to the present invention is as follows.

In the initial state of shaving apparatus 1 (not shown), actuation of on/off switch 5 sets electric drive motor 47 into operation. Drive shaft 52 then rotates, with drive element 6 and eccentric pin 32 connected integrally thereto. Rotating eccentric pin 32 transmits its back-and-forth movement to eccentric coupling 51, which transmits its movement to lower blade 48 of short hair cutting system 3 via drive pin 49. The oscillatory movement runs perpendicular to longitudinal axis 88 of shaving apparatus 1. In this state, short hair cutting system 3 can be used to shave very short hairs protruding from the surface of the skin (fine shaving) if these hairs reach lower blade 48 via perforated upper blade 4. In this position, the two long hair cutting devices 9 and 10 are not driven; i.e., cutting blades 31 and 37 do not execute any movement relative to associated cutting combs 30 and 36. In the initial position of shaving apparatus 1, first long hair cutting device 9 is situated lower than short hair cutting system 3, and allows a view of the operating area thereof.

If, according to FIGS. 1 through 3 and 11, sliding switch 7 is now displaced upward relative to housing 2 by a specified distance z in the longitudinal direction of housing 2, coupling flanges 20 of double lever 16 engage in drive element 6. When this position, defined by corresponding stops on housing 2 and sliding switch 7, has been reached, double lever 16 oscillates, driven by drive element 6, about pin 54 of bearing point 17. Because drive pin 19, which extends at a right angle from double lever 16, engages in receptacles 40, 35, which extend upward and downward with an oval shape, of downstream levers 39, 34, these levers oscillate about their associated pins 41 or, respectively, 71. In this second operating state of hair cutting device 1, cutting blades 31 or 37 execute an oscillating linear movement relative to their cutting combs 30 or 36, but always opposed to one another.

In this second operating state, first long hair cutting device 9, which has a broad construction, is oriented upward, and its height extends past that of short hair cutting device 3. With first long hair cutting device 9 it is now possible for example to remove longer hairs or to pre-trim them no that they can then be better engaged and shaved off by short hair cutting system 3. The exposed position of first long hair cutting device 9 makes it easy to view and to use. In particular, it is also very well suited for contour cutting, for example of sideburns or stubble beards.

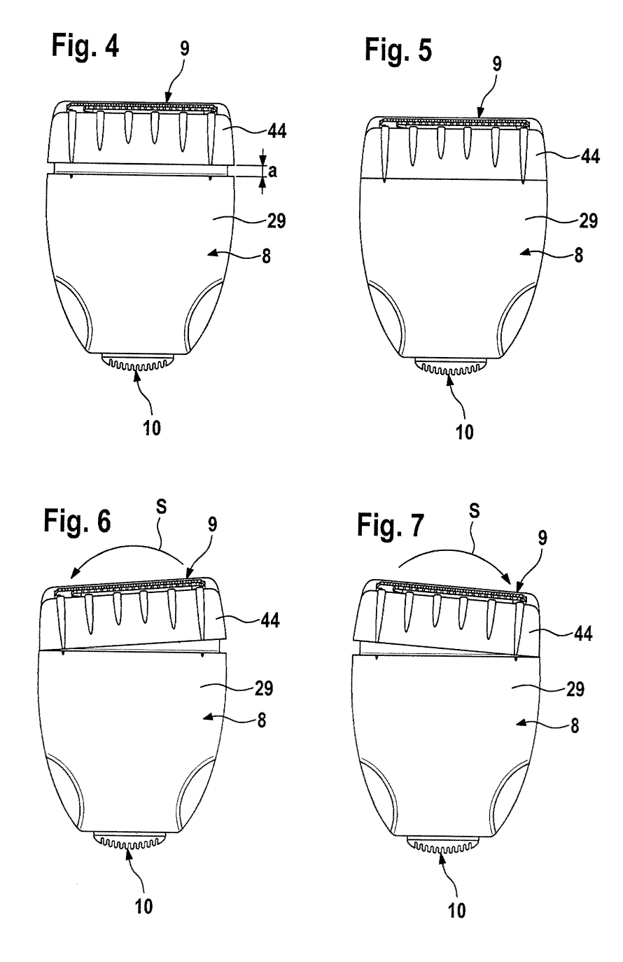

Shaving using first long hair cutting device 9 is particularly gentle on the skin, because when, according to FIGS. 2 and 3, pressure is exerted on cutting comb 30, or on housing part 89 connected to cutting comb 30, long hair cutting device 9 as a whole is either, depending on the introduction of force, lowered uniformly (surface pressure p constant over the entire width) or is both lowered and slightly rotated to the left or to the right. For example, FIG. 1 shows a position in which a surface force p acts uniformly from above on first long hair cutting device 9. It will be seen that in contrast to FIG. 1, in FIG. 2 first long hair cutting device 9 is lowered by the distance a (FIG. 4). Here, shaving head frame 44 has been lowered symmetrically to center line 65, and is guided uniformly at both sides via support feet 61 in sliding guide 73. Here, spiral springs 79 are uniformly further compressed, and increase the reaction force on shaving head frame 44. As soon as surface pressure p decreases, spiral springs 79 cause shaving head frame 44 to move back to its initial position according to FIG. 1.

If, according to FIG. 3, both a surface force p and an additional off-center force F1 act on first long hair cutting device 9 from above, on the one hand shaving head frame 44 moves downward in sliding guide 73, and simultaneously rotates in the clockwise direction according to pivot direction S shown in FIG. 7. Here, according to FIGS. 3 and 7, the right part of shaving head frame 44 is lowered more than is the left part. In this way, according to FIG. 8 right spiral spring 79 is more strongly compressed than is left spiral spring 79. The slight rotation of shaving head frame 44 about bearing pin 74 is also possible because external side surfaces 99 of support feet 61 taper downward according to FIG. 9; i.e., between side surfaces 99 and external limit surfaces 100 of sliding guide 73, an amount of play (not shown) is present that permits the pivot movement.

The possible lowering or pivoting of shaving head frame 44 against the forces of spiral springs 79 results in a long hair cutting device 9 with which the skin surface is not only treated in a particularly gentle manner during shaving, but optimal shaving results are achieved due to the full contact of the free ends of the cutting comb 30 with the surface of the skin. This is because given even slight pressure on shaving head frame 44, or cutting comb 30, these respond to the pressure by yielding, through lowering and pivoting, in a manner corresponding to the surface of the skin. If displacement of shaving head frame 44 during shaving is not desired, this can be blocked using arrest slider 57. In this case, this slider is moved to the right in recess 60 according to FIG. 1, but this is not shown there.

If the user desires to cut finer contours, bearer part 8, together with long hair cutting devices 9, 10, is pivoted by 180° in direction of rotation D in order to reach a third position, so that cutting comb 36, with cutting blade 37, which is at the bottom in FIG. 8, becomes situated at the top (this is not shown in the drawings). Here, ratchet arrangement 59 must first be unlocked by applying a stronger rotating force, and can then be further rotated more easily. After the third position has been reached, according to FIG. 10 right cam 42 snaps into stationary left indentation 43. Second long hair cutting device 10 is now in an optimal operating position. In this operational state as well, sliding switch 7 can remain snapped into its upper switching position. Second long hair cutting device 10, which has a narrower construction and is now in the operational position, is used for the cutting of finer contours, for example in beards.

Because axis of rotation 11 runs eccentrically relative to the position of the two long hair cutting devices 9 and 10, and because the distance of second long hair cutting device 10 from axis of rotation 11 is approximately twice as great as the distance between axis of rotation 11 and first long hair cutting device 9, second long hair cutting device 10, fashioned as a styler, extends further past short hair cutting system 3 than it does past first long hair cutting device 9 in the second operating state. Because of this, the visibility during use of second long hair cutting device 10 is even better than is already the case when first long hair cutting device 9 is being used.

In an embodiment not shown in the drawings, it can also be provided that the pivot movement of bearer element 8, and/or the longitudinal displacement of sliding switch 7, takes place using suitable electric actuating drives that are controlled by the user via corresponding electric switching elements.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An electrically operated hair cutting device having a short hair cutting system fashioned on a front end of a housing and having a bearer part, attached to the front or rear side of the housing, that accepts at least one additional cutting device that is made up of at least two cutting elements that slide relative to one another via a drive motor, the cutting elements of the additional cutting device being fashioned in a shaving head frame that can be lowered, with the cutting elements, against the force of a spring arrangement by a prespecified distance relative to the bearer part, the shaving head frame being guided upward and downward via guide elements on the bearer part, wherein the shaving head frame is pivotably mounted on the bearer part via a central bearing.

2. The hair cutting device of claim 1, wherein the central bearing comprises a bearing pin that is fashioned on the shaving head frame and that engages in a groove fashioned in the bearer part, the groove being dimensioned so as to be long enough in the direction of the upward and downward movement of the shaving head frame that it permits the movement of the bearing pin.

3. The hair cutting device of claim 2, wherein one cutting element of the additional cutting device stands in engagement with a pivot lever that is pivotable about a pin, and that the engagement is formed by a coupling arrangement, and that the coupling arrangement has means that permit both a rotation and an upward and downward movement of the one cutting element.

4. The hair cutting device of claim 3, wherein the pivot lever has a free end and a fork-shaped claw is attached to said free end of the pivot lever, wherein said claw has free ends and outer walls, and further, wherein said fork-shaped claw engages in a shaft fashioned on the cutting blade, such that in the initial position of the cutting blade there is a distance between the free ends of the claw and the end of the shaft, and that the outer walls of the claw, which stand in sliding contact with the walls of the shaft, are curved outward.

5. The hair cutting device of claim 1, wherein supports are attached to both sides of the shaving head frame, said supports having free ends, and that on the free ends of the supports there are fashioned centering pins, and that, in prolongation of the supports, receptacles are fashioned on the bearer part at a distance, and that the centering pins are connected with the associated receptacles by a respective spring.

6. The hair cutting device of claim 5, wherein between the shaving head frame and the bearer part there are fashioned stop means that always bring the shaving head frame into its initial position due to the action of the force of the spiral springs.

7. The hair cutting device of claim 5, wherein the springs are formed by spiral springs.

8. The hair cutting device of claim 1, wherein the bearer part is mounted on a sliding switch that is displaceable on the housing of the hair cutting device.

9. The hair cutting device of claim 1, wherein both the short hair cutting system and the additional long hair cutting device fashioned in the bearer part are driven by a common electric drive motor.

10. The hair cutting device of claim 8, wherein the bearer part as well as the sliding switch are mounted in linearly displaceable fashion on the housing of the hair cutting device.

11. The hair cutting device of claim 1, wherein the bearer part is mounted on the housing of the hair cutting device so as to be pivotable about an axis of rotation, and that the additional cutting device consists of two long hair cutting devices situated at a distance from one another, and that the two long hair cutting devices are fashioned diametrally on the bearer art.

12. The hair cutting device of claim 11, wherein between the bearer part and the shaving head frame an arrest device that can be actuated manually is provided that prevents lowering or pivoting of the one long hair cutting device.
